(19) United States
(12) Patent Application Publication
(10) Pub. No.: US 2008/0267763 A1
(43) Pub. Date: Oct. 30, 2008

(54) Rotary machine including a passive axial balancing system

(75) Inventors: Fabien Wahl, Saint Marcel (FR); Laurent Fabbri, Meulan (FR); Francois Danguy, Tourny (FR)

Correspondence Address: WEINGARTEN, SCHURGIN, GAGNEBIN & LEBOVICI LLP, TEN POST OFFICE SQUARE, BOSTON, MA, 02109, US

(73) Assignee: SNECMA

(21) Appl. No.: 11/811,638

(22) Filed: Jun. 11, 2007

(30) Foreign Application Priority Data
Apr. 30, 2007 (FR) 0754787

(51) Int. Cl. F03B 15/06

(52) U.S. Cl. 415/4.5

(57) ABSTRACT

The invention relates to a rotary machine for passing a main liquid stream, the machine comprising:
a shaft mounted to rotate relative to a casing of the rotary machine; and
an active axial balancing system suitable for exerting a first axial take-up force on the shaft.

The invention further comprising a circuit for a secondary liquid stream taken from the main liquid stream, and a passive axial balancing system suitable for exerting a second axial take-up force on the shaft, said passive axial balancing system being fed by the circuit for the secondary liquid stream.

The present invention relates to the field of rotary machines for passing a main liquid stream, such as, for example, suction pumps or turbines for generating electrical power. If the rotary machine is a pump, then the main liquid stream is the liquid the pump sucks in, whereas if the rotary machine is turbine, then the main liquid stream is the liquid that is injected into the turbine.

### BACKGROUND OF THE INVENTION

The rotary machine generally includes an electrical member constituted by a rotor and a stator, which member is an electric motor when the machine is operating as a pump, and is a generator when the machine is operating as a turbine.

Such a rotary machine is often designed to be installed vertically, i.e. with its axis of rotation extending generally vertically, such that the “bottom” and the “top” of the pump can be defined relative to such a vertical axis.

The terms “axial”, “radial”, and “tangential” are likewise defined relative to the axis of the machine.

Because of the considerable weight of certain rotary elements in such a rotary machine, in particular the weight of the electrical member and of the rotary shaft secured to the rotor of the electrical member, it will be understood that the downward force of that weight tending to move those elements downwards is large.

In addition, when the machine operates as a pump, the reaction due to the pumping induces a traction force that pulls the rotary shaft of the machine downwards together with the elements that are secured thereto.

This initial force is additional to the force of gravity so the rotary shaft is subjected to large forces directed axially downwards relative to the machine.

As a result, the bearings that serve to guide rotation of the rotary shaft are heavily stressed axially by these forces, thereby reducing their lifetime.

To mitigate that drawback, such rotary machines generally include an active axial balancing system, such as that described in U.S. Pat. No. 4,538,960, enabling said forces to be compensated in full or in part, by exerting an axial take-up force on the shaft in a direction opposite to that of the force of gravity.

It will be understood that it is desired to obtain an axial take-up force of magnitude that is substantially equal to the magnitude of the forces to be compensated, which forces are constituted by the force of gravity plus the traction force.

In practice, the intensity of the forces to be compensated can fluctuate, e.g. because of fluctuation in the flow rate of the main liquid stream, such that the magnitude of the axial take-up force can suddenly become greater than the magnitude of the forces to be compensated, thereby causing the shaft to move upwards relative to the machine.

In the absence of an active axial balancing system, such an axial thrust on the shaft can lead to fatigue in the bearings, thereby reducing their lifetime.

In an active axial balancing system, the magnitude of the axial take-up force depends on the displacement of the rotary shaft relative to the casing. This enables the magnitude of the axial take-up force to be regulated.

Thus, the magnitude of the axial take-up force decreases if the magnitude of the axial take-up force becomes greater than the magnitude of the forces to be compensated, and conversely the axial take-up force increases if the magnitude of the axial take-up force becomes less than the magnitude of the forces to be compensated. In other words, the magnitude of the axial take-up force is servo-controlled to the displacement of the rotary shaft.

It will thus be understood that by means of the active axial balancing system, the magnitude of the axial take-up force is regulated actively.

The present invention thus relates to such a rotary machine for passing a main liquid stream, the machine comprising:
a shaft mounted to rotate relative to a casing of the rotary machine; and
an active axial balancing system suitable for exerting a first axial take-up force on the shaft.

Nevertheless, it has been found in certain situations that the magnitude of the axial take-up force exerted by the active axial take-up system is not sufficiently large.

### OBJECTS AND SUMMARY OF THE INVENTION

An object of the present invention is to provide a rotary machine having improved capacity for axial take-up.

The invention achieves this object by the fact that the rotary machine of the present invention further comprises a circuit for a secondary liquid stream taken from the main liquid stream, and a passive axial balancing system suitable for exerting a second axial take-up force on the shaft, said passive axial balancing system being fed by the circuit for the secondary liquid stream.

In the meaning of the invention, the passive axial balancing system differs from the active axial balancing system in that the magnitude of the second force is not servo-controlled to the displacement of the shaft relative to the casing.

In other words, the magnitude of the second force is constant regardless of the displacement of the rotary shaft relative to the casing.

Furthermore, like the first axial take-up force, the second axial take-up force operates in a direction opposite to that of the force of gravity when the machine is installed vertically.

When the rotary machine of the invention is a pump, the second axial take-up force acts in a direction opposite to that of the above-mentioned traction force.

The passive axial balancing system, distinct from the active axial balancing system, thus delivers an additional axial take-up force, i.e. the second axial take-up force, whereby the magnitude of the overall axial take-up force acting on the rotary shaft is advantageously increased.

In the invention, the flow rate of the secondary liquid stream is substantially less than that of the main liquid stream.

Also, in the invention, the secondary liquid stream flowing in the circuit while the machine is in operation advantageously feeds the passive axial balancing system, i.e. the secondary liquid stream supplies the energy needed for operating the passive axial balancing system.

Advantageously, the passive axial balancing system has an annular passage between the shaft and the casing through which the secondary liquid stream is to flow, said passage axially separating an upstream fluid-flow chamber from a downstream fluid-flow chamber in such a manner that the pressure in the upstream fluid-flow chamber is greater than the pressure in the downstream fluid-flow chamber.

The terms “upstream” and “downstream” are used herein relative to the flow direction of the secondary liquid stream.

The pressure difference between the two chambers is due to the fact that the annular passage constitutes a flow constriction for the secondary liquid stream.

Advantageously, the annular passage is defined between the casing and a disk secured to the shaft.

Preferably, the annular passage is defined radially between the outer periphery of the disk and an inside surface of the casing.

Furthermore, the disk preferably extends radially from the axis of the rotary shaft so that it separates the upstream chamber axially from the downstream chamber. The second axial take-up force, resulting from the pressure difference between the upstream and downstream chambers thus acts on the rotary shaft via the disk.

Advantageously, the disk includes at its periphery an annular labyrinth seal.

The annular passage is thus defined radially between the labyrinth seal and the inside surface of the casing.

In particularly advantageous manner, the passive axial balancing system further comprises means for calibrating the flow rate of the secondary liquid stream.

The flow rate of the secondary liquid stream must not be too great since that would decrease the efficiency of the machine.

By means of the present invention, the flow rate of the secondary liquid stream is calibrated so that a second axial take-up force is obtained that is sufficient, but without excessively reducing the efficiency of the rotary machine.

Advantageously, the means for calibrating the flow rate of the secondary liquid stream comprise said annular passage.

In other words, the annular passage contributes both to generating the second axial take-up force and to calibrating the flow rate of the secondary liquid stream.

Advantageously, the annular passage presents a predetermined radial extent for the purpose of calibrating the flow rate of the secondary liquid stream.

Preferably, the radial extent corresponds to the radial clearance that exists between the disk and the casing.

Advantageously, the secondary liquid stream is also used for cooling a rotary element of the machine.

Thus, the secondary liquid stream constitutes a stream of cooling liquid. Under such circumstances, the cooling liquid stream is advantageously calibrated so that the cooling of the rotary element is sufficient.

In the meaning of the invention, the rotary element is an element having at least one component part that is driven in rotation by the shaft.

Preferably, the rotary element is a bearing, a motor, and/or an electricity generator. The machine of the invention may have a plurality of rotary elements selected from the above-mentioned elements.

Since the rotary element heats up during operation of the machine, it is necessary to cool it.

By means of the invention, the same liquid stream is used both for cooling the rotary element and for feeding the passive axial balancing system. There is therefore no need to provide distinct circuit, thereby advantageously simplifying the structure of the machine.

In a first variant, the rotary machine is a pump.

In a second variant, the rotary machine is a turbine.

### BRIEF DESCRIPTION OF THE DRAWINGS

The invention can be understood and its advantages appear better in the light of the following detailed description of an embodiment given by way of non-limiting example. The description refers to the accompanying drawings, in which:

FIG. 1 is a section view of a rotary machine of the present invention, the machine being a pump; and

FIG. 2 is a detail view of the FIG. 1 rotary machine, showing the passive axial balancing system of the invention.

### MORE DETAILED DESCRIPTION

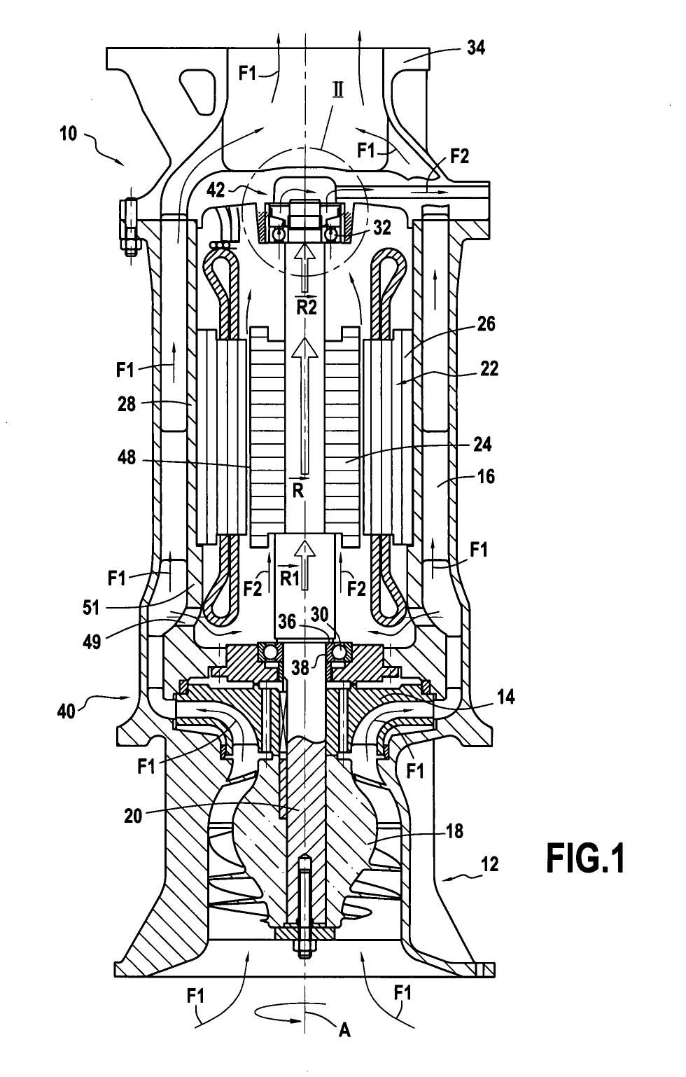

FIG. 1 shows an example of a rotary machine 10 in accordance with the present invention, the rotary machine 10 preferably, but not exclusively, being designed for pumping a fluid such as a liquefied gas. It can advantageously be used for emptying the tanks of a methane tanker.

The example shown in FIG. 1 is not limiting, it being equally possible for the rotary machine of the invention to be a turbine through which a liquid flow drives a generator that delivers electrical power.

In the description below, the adjectives “axial”, “tangential”, and “radial” are defined relative to the axis of rotation A of the machine 10.

The rotary machine 10 is generally designed to be installed vertically, and the adjectives “bottom” and “top” are defined relative to the vertical direction.

When considered along the suction direction of the main stream of liquid represented herein by arrows referenced F1, the machine 10 comprises in succession: a suction stage 12; a centrifugal impeller 14; and an annular duct 16 for delivering the sucked-in liquid.

The suction stage 12 includes a rotary inducer 18 rotated by a rotary shaft 20 of the machine 10, the rotary shaft 20 itself being driven by a rotary element constituted by an electric motor 22.

The electric motor 22 comprises a rotor 24 secured to the shaft 20, and a stator 26 secured to a casing 28 of the machine 10.

As can be seen in FIG. 1, the rotary shaft 20 is mounted to rotate relative to the shaft 21 via a bottom bearing 30 situated between the centrifugal impeller 14 and the motor 22, and a top bearing 32 situated between the motor 22 and a delivery sleeve 34.

The rotary shaft 20 includes a shoulder 36 that comes into axial abutment against an inner ring 38 of the bottom bearing 30.

Since the machine 10 is disposed vertically, it will be understood that the bottom bearing 30 supports the weight of the rotary shaft, of the centrifugal impeller 14, of the rotor 24, and of the inducer 18, which weight has added thereto the traction force to which the inducer 18 is subjected while sucking in liquid.

To take up at least a portion of the resultant of the above-mentioned forces, the machine 10 further includes an active axial balancing system 40, of well-known type, suitable for exerting a first axial take-up force R1 on the shaft 20.

This force take-up is implemented by the first axial take-up force R1 opposing the resultant of the above-mentioned forces.

In known manner, the active axial balancing system 40 also serves to regulate the magnitude of the first axial take-up force R1. More precisely, the regulation depends on the axial displacement of the shaft 20 relative to the casing 28.

In practice, if the magnitude of the first axial take-up force R1 is greater than that of the resultant of the forces to be taken up, then the active axial balancing system 40 performs regulation by reducing the magnitude of the first axial take-up force R1.

It has been found that the active axial balancing system 40 does not provide sufficient performance when the flow rate of the main stream F1 of pumped liquid is low. More precisely, it has been found that the regulation means do not operate properly at low flow rates.

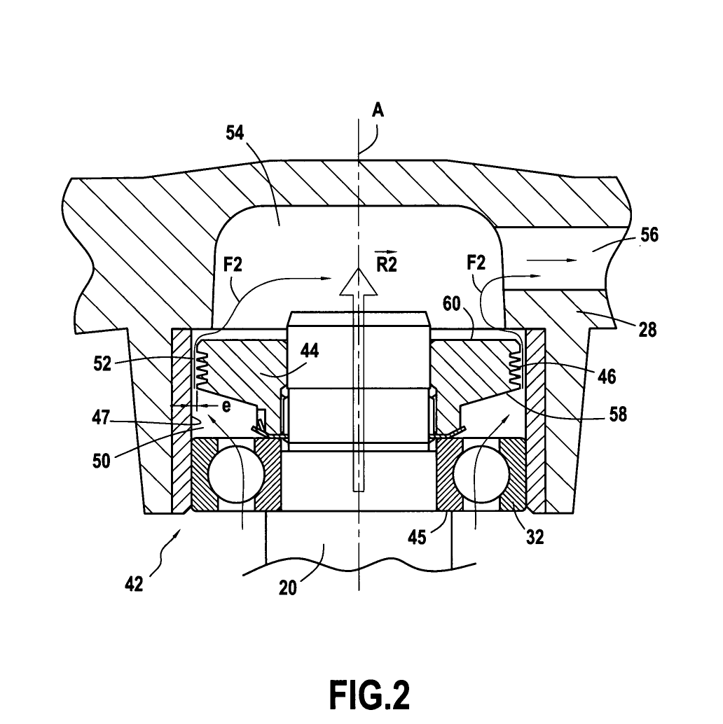

To remedy that drawback, the rotary machine 10 further includes, in particularly advantageous manner, a passive axial balancing system 42 that can be seen more clearly in FIG. 2 and that is suitable for exerting a second axial take-up force R2 on the shaft 20.

This axial balancing system 42 is passive, i.e. unlike the active axial balancing system, the second axial take-up force R2 is independent of the axial displacement of the shaft 20 relative to the casing 28.

In FIG. 2, it can be seen that the passive axial balancing system 42 comprises a disk 44 secured to the top end of the shaft 20.

The disk 44 is suitable for sliding in a bore 47 made in the casing 28.

The top bearing 32 is preferably mounted between the disk 44 and a shoulder 45 of the shaft 20.

The disk 44 preferably includes an annular labyrinth seal 46 at its periphery. Nevertheless, it is possible to provide other types of seal.

In accordance with the invention, the passive axial balancing system 42 is fed by a circuit conveying a secondary liquid stream F2 that is taken from the main liquid stream F1, specifically via a radial passage 49 formed through an inside surface 51 of the annular duct 16.

As can be seen in FIG. 1, this secondary stream F2 passes through the airgap 48 of the motor 42, thereby advantageously cooling the motor.

In FIG. 2, it can be seen that the secondary liquid stream F2 then passes through the top bearing 32, thus advantageously cooling said top bearing, prior to penetrating into an upstream fluid-flow chamber 50 disposed axially upstream from the disk 44.

The secondary liquid stream F2 then flows through an annular passage 52 defined radially between the outside periphery of the disk 44 and the casing 28, and then flows through a downstream fluid-flow chamber 54 disposed axially downstream from the disk 44. This downstream fluid-flow chamber is preferably connected to a discharge orifice 56 for discharging the secondary liquid stream F2 out from the rotary machine 10. The terms “upstream” and “downstream” are used herein relative to the flow direction of the secondary liquid stream F2.

As shown in FIG. 2, the annular passage 52 axially separates the upstream fluid-flow chamber from the downstream fluid-flow chamber 54.

As mentioned above, the annular passage 52 forms a flow constriction for the secondary liquid stream F2, such that the pressure in the upstream fluid-flow chamber 50 is greater than the pressure in the downstream fluid-flow chamber 54.

It follows that it exerts on the upstream face 58 of the disk 44 a pressure that is greater than that exerted on the downstream face 60 of the disk 44. This pressure difference thus generates the second axial take-up force R2 that acts on the shaft 20 via the disk 44.

It should also be understood that the magnitude of this second axial take-up force R2 depends on the radial clearance between the disk 44 and the casing 28 and not on the displacement of the shaft 20 relative to the casing 28.

That is why the axial balancing system 42 is said to be “passive”. Consequently, the overall axial take-up force R acting on the shaft 20 is the sum of the first and second axial take-up forces R1, R2.

In particularly advantageous manner, the passive axial balancing system 42 further comprises calibration means for calibrating the flow rate of the secondary liquid stream F2. Specifically, these calibration means comprise the annular passage 52.

Specifically, the annular passage 52 presents a predetermined radial extent e that serves to calibrate the flow rate of the secondary liquid stream F2.

This radial extension e is defined between the outer periphery of the disk 44 and the casing 28.

As mentioned above, the secondary liquid stream F2 is also used, advantageously, to cool the rotary elements of the machine 10, specifically the motor 22 and the bearing 32.

It is advantageous to calibrate the flow rate of this cooling liquid stream, since a rate that is too small will not cool the rotary elements sufficiently, while a rate that is too great will reduce the efficiency of the machine, which efficiency is a function of the flow rate of the main liquid stream F1. It can be understood that if too great a secondary liquid stream F2 is taken, then the main stream F1 is reduced correspondingly.

In other words, by means of the invention, the flow rate of the motor-cooling stream is calibrated to be constant, regardless of the axial position of the rotor 24.

As mentioned above, the rotary machine of the invention could also be a turbine. Under such circumstances, the main liquid stream flows in a direction opposite to that of the main liquid stream F1 of a machine operating as a pump. In contrast, the secondary liquid stream through the turbine flows in the same flow direction as the secondary liquid stream F2 flowing in the pump.

1. A rotary machine for passing a main liquid stream, the machine comprising:
a shaft mounted to rotate relative to a casing of the rotary machine; and
an active axial balancing system suitable for exerting a first axial take-up force on the shaft;
said machine further comprising a circuit for a secondary liquid stream taken from the main liquid stream, and a passive axial balancing system suitable for exerting a second axial take-up force on the shaft, said passive axial balancing system being fed by the circuit for the secondary liquid stream.

2. A rotary machine according to claim 1, wherein the passive axial balancing system has an annular passage between the shaft and the casing through which the secondary liquid stream is to flow, said passage axially separating an upstream fluid-flow chamber from a downstream fluid-flow chamber in such a manner that the pressure in the upstream fluid-flow chamber is greater than the pressure in the downstream fluid-flow chamber.

3. A rotary machine according to claim 2, wherein the downstream fluid-flow chamber is connected to a discharge orifice.

4. A rotary machine according to claim 2, wherein the annular passage is defined between the casing and a disk secured to the shaft.

5. A rotary machine according to claim 4, wherein the disk is secured to one end of the shaft.

6. A rotary machine according to claim 4, wherein the disk includes at its periphery an annular labyrinth seal.

7. A rotary machine according to claim 1, wherein the passive axial balancing system further comprises means for calibrating the flow rate of the secondary liquid stream.

8. A rotary machine according to claim 2, wherein the passive axial balancing system further comprises means for calibrating the flow rate of the secondary liquid stream, and wherein the means for calibrating the flow rate of the secondary liquid stream comprise said annular passage.

9. A rotary machine according to claim 8, wherein the annular passage presents a predetermined radial extent for the purpose of calibrating the flow rate of the secondary liquid stream.

10. A rotary machine according to claim 1, wherein the secondary liquid stream is also used for cooling a rotary element of the machine.

11. A rotary machine according to claim 10, wherein the rotary element is a bearing, a motor, and/or an electricity generator.

12. A rotary machine according to claim 1, the rotary machine being a pump.

13. A rotary machine according to claim 1, the rotary machine being a turbine.

14. A rotary machine for passing a main liquid stream, the machine comprising:
a shaft mounted to rotate relative to a casing of the rotary machine; and
an active axial balancing system suitable for exerting a first axial take-up force on the shaft;
said machine further comprising a circuit for a secondary liquid stream taken from the main liquid stream, and a passive axial balancing system suitable for exerting a second axial take-up force on the shaft, said passive axial balancing system being fed by the circuit for the secondary liquid stream, wherein the passive axial balancing system has an annular passage between the shaft and the casing through which the secondary liquid stream is to flow, said passage axially separating an upstream fluid-flow chamber from a downstream fluid-flow chamber in such a manner that the pressure in the upstream fluid-flow chamber, and wherein the secondary liquid stream is also used for cooling a rotary element of the machine.

15. A rotary machine according to claim 14, wherein the passive axial balancing system further comprises means for calibrating the flow rate of the secondary liquid stream, and wherein the means for calibrating the flow rate of the secondary liquid stream comprise said annular passage.

16. A rotary machine according to claim 15, wherein the annular passage presents a predetermined radial extent for the purpose of calibrating the flow rate of the secondary liquid stream.
